(19) United States
(12) Patent Application Publication
(10) Pub. No.: US 2025/0358529 A1
(43) Pub. Date: Nov. 20, 2025

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: HIROTAKA OMORI, Kanagawa (JP); TOSHIYUKI DOBASHI, Kanagawa (JP)

(21) Appl. No.: 19/189,610

(22) Filed: Apr. 25, 2025

(30) Foreign Application Priority Data
May 15, 2024 (JP) 2024-079715
Dec. 3, 2024 (JP) 2024-210772

(51) Int. Cl. H04N 23/73; G06V 10/25; G06V 10/75; H04N 23/12; H04N 23/13; H04N 23/71

(52) U.S. Cl. CPC H04N 23/73; G06V 10/25; G06V 10/759; H04N 23/71; H04N 23/12; H04N 23/13

(57) ABSTRACT

An image processing apparatus comprises an identification unit configured to identify a region, among regions of subjects detected in a first image obtained by imaging in which invisible light is used, that does not correspond to a region of a subject detected in a second image obtained by imaging in which visible light is used, and a control unit configured to control, based on the region identified by the identification unit, exposure for imaging in which visible light is used.

### BACKGROUND OF THE INVENTION

### Field of the Invention

The present invention relates to an image processing technique.

### Description of the Related Art

Imaging systems that include a visible light camera and an invisible light (infrared) camera are known (e.g., Japanese Patent No. 6356925). In Japanese Patent No. 6356925, a visible light camera and an invisible light (infrared) camera capture, at about the same angle and at about the same imaging magnification, a target area in which object detection will be performed. In Japanese Patent No. 6356925, object detection is performed in each of a visible light image captured by the visible light camera and an infrared image (temperature distribution image) captured by the invisible light camera. In Japanese Patent No. 6356925, respective detection result scores of the infrared image and the visible light image are weighted and added based on surrounding infrared energy, a region where a detection target is present is determined based on that result, and exposure correction of the visible light image is performed based on that region.

However, Japanese Patent No. 6356925 does not describe in detail a method of exposure correction for when a plurality of subjects are detected. In Japanese Patent No. 6356925, when exposure correction is performed on a plurality of subjects at the same time, desirable exposure correction may not be performed for all the subjects depending on the brightnesses of the subjects. Further, even if some subjects are selected and exposure correction is performed, desired exposure may not be obtained for other subjects.

### SUMMARY OF THE INVENTION

The present invention provides a technique for allowing exposure control suitable for detecting a subject.

According to the first aspect of the present disclosure, there is provided an image processing apparatus comprising: an identification unit configured to identify a region, among regions of subjects detected in a first image obtained by imaging in which invisible light is used, that does not correspond to a region of a subject detected in a second image obtained by imaging in which visible light is used; and a control unit configured to control, based on the region identified by the identification unit, exposure for imaging in which visible light is used.

According to the second aspect of the present disclosure, there is provided an image processing method to be performed by an image processing apparatus, the method comprising: identifying a region, among regions of subjects detected in a first image obtained by imaging in which invisible light is used, that does not correspond to a region of a subject detected in a second image obtained by imaging in which visible light is used; and controlling, based on the identified region, exposure for imaging in which visible light is used.

According to the third aspect of the present disclosure, there is provided a non-transitory computer-readable storage medium storing a computer program for causing a computer to function as: an identification unit configured to identify a region, among regions of subjects detected in a first image obtained by imaging in which invisible light is used, that does not correspond to a region of a subject detected in a second image obtained by imaging in which visible light is used; and a control unit configured to control, based on the region identified by the identification unit, exposure for imaging in which visible light is used.

Further features of the present invention will become apparent from the following description of exemplary embodiments with reference to the attached drawings.

### BRIEF DESCRIPTION OF THE DRAWINGS

FIG. 1 is a block diagram illustrating an example of a functional configuration of a system.

FIG. 2 is a flowchart for exposure control of a visible light camera 101 by an image processing apparatus 103.

FIG. 3A is a diagram illustrating an example of a visible light image.

FIG. 3B is a diagram illustrating an example of an invisible light image.

FIG. 4A is a diagram illustrating an example of a visible light image.

FIG. 4B is a diagram illustrating an example of an invisible light image.

FIG. 5A is a diagram illustrating an example of a visible light image.

FIG. 5B is a diagram illustrating an example of an invisible light image.

FIG. 6 is a block diagram illustrating an example of a functional configuration of a system.

FIG. 7 is a flowchart for explaining subject tracking processing performed by the image processing apparatus 103.

FIG. 8A is a diagram illustrating an example of a visible light image.

FIG. 8B is a diagram illustrating an example of an invisible light image.

FIG. 9 is a block diagram illustrating an example of a hardware configuration of a computer apparatus applicable to the image processing apparatus 103.

FIG. 10A is a diagram illustrating an example of a visible light image.

FIG. 10B is a diagram illustrating an example of an invisible light image.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

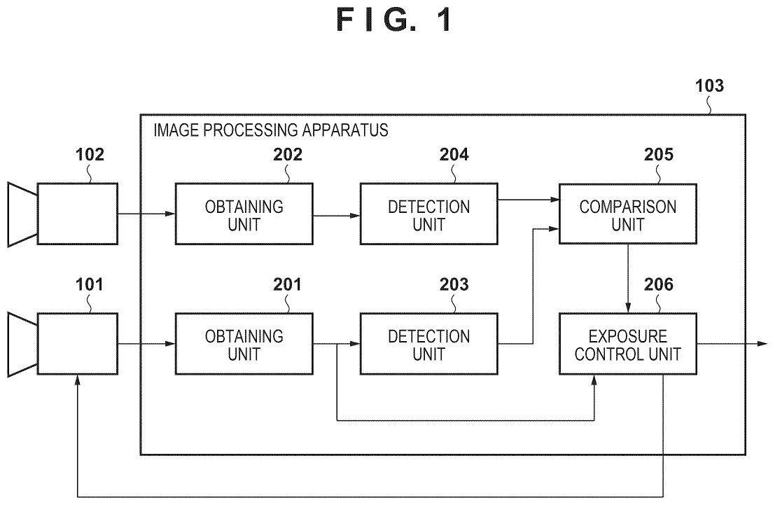

An example of a functional configuration of a system according to the present embodiment will be described with reference to a block diagram of FIG. 1. As illustrated in FIG. 1, the system according to the present embodiment includes a visible light camera 101, which is an imaging apparatus that performs imaging in which visible light is used; an invisible light camera 102, which is an imaging apparatus that performs imaging in which invisible light, which cannot be captured by the visible light camera 101, is used; and an image processing apparatus 103 for controlling exposure of the visible light camera 101. The visible light camera 101 and the image processing apparatus 103 are directly or indirectly connected via a network, such as a LAN or the Internet. Similarly, the invisible light camera 102 and the image processing apparatus 103 are directly or indirectly connected via a network, such as a LAN or the Internet. However, forms of connection between the visible light camera 101 and the image processing apparatus 103 and between the invisible light camera 102 and the image processing apparatus 103 are not limited to a specific connection form.

The visible light camera 101 includes an imaging optical system including one or more lenses, a visible light imaging element (visible light sensor) for capturing an optical image formed by the imaging optical system and converting it into an electrical signal, and an image processing circuit for generating a captured image based on that electrical signal. The visible light sensor detects visible light in a range, for example, from about 380 nm to about 750 nm in wavelength. The visible light sensor may have sensitivity in at least a portion of the wavelength region of near-infrared light.

The invisible light camera 102 is, as described above, an imaging apparatus that performs imaging using invisible light, which cannot be captured by the visible light camera 101, and invisible light includes, for example, infrared light, millimeter waves, terahertz waves, and the like. In the present embodiment, it is assumed that the invisible light camera 102 captures infrared light. The invisible light camera 102 includes an imaging optical system including one or more lenses, an infrared imaging element (infrared sensor) for capturing an optical image formed by the imaging optical system and converting it into an electrical signal, and an image processing circuit for generating a captured image based on that electrical signal. The infrared sensor detects infrared light in a range, for example, from about 0.83 μm to about 1000 μm in wavelength. In the present embodiment, it is assumed that far-infrared light in a range from 6 μm to 1000 μm in wavelength is detected. A thermal-type infrared sensor, such as a microbolometer or one that is a silicon on insulator (SOI) diode-type, may be used as the infrared sensor. The visible light camera 101 and the invisible light camera 102 capture substantially the same imaging region.

Next, the image processing apparatus 103 will be described. The image processing apparatus 103 controls exposure of the visible light camera 101 based on a region among regions of subjects detected in a captured image obtained by the invisible light camera 102 that does not correspond to a region of a subject detected in a captured image obtained by the visible light camera 101.

An obtaining unit 201 obtains an image captured by the visible light camera 101 as a visible light image. An obtaining unit 202 obtains an image captured by the invisible light camera 102 as an invisible light image.

A detection unit 203 detects a subject in a visible light image. Various methods, such as a pattern matching method, a method in which a luminance gradient within a local region is used, a method based on machine learning (e.g., deep learning), and the like, can be employed as a method of detecting a subject from a visible light image. In the present embodiment, as an example, the detection unit 203 detects a subject in a visible light image using a trained model that has been trained in advance by deep learning.

A detection unit 204 detects a subject in an invisible light image. A method of detecting a subject in an invisible light image may be the same as the method of detecting a subject in a visible light image or may be a method different from the method of detecting a subject in a visible light image. In the present embodiment, as an example, the detection unit 204 detects a subject in an invisible light image using the same method as the detection unit 203.

Even if the respective subject detection methods of the detection unit 203 and the detection unit 204 are the same, the models trained by machine learning, such as deep learning, for example, may be different or the same between the detection unit 203 and the detection unit 204. In the present embodiment, as an example, it is assumed that the detection unit 203 performs subject detection processing for a visible light image using a “trained model (first model) that has been trained to detect a person in an image using facial and color features”. Further, in the present embodiment, as an example, it is assumed that the detection unit 204 performs subject detection processing for an invisible light image using a “trained model (second model) that has been trained to detect a person in an image using a human silhouette”. Furthermore, in the present embodiment, detection reliability is also calculated in a region of a detected subject. Here, regarding detection reliability, it is assumed that a value normalized to 0 to 1 is calculated, and the greater the value, the greater the index indicating a likelihood of being a detection target.

A comparison unit 205 identifies a region among regions of subjects detected by the detection unit 204 that does not correspond to a region of a subject detected by the detection unit 203 and generates region information defining that identified region.

An exposure control unit 206 obtains an amount of correction of exposure for the visible light camera 101 based on the region defined by the region information in the visible light image and controls exposure of the visible light camera 101 based on that amount of correction.

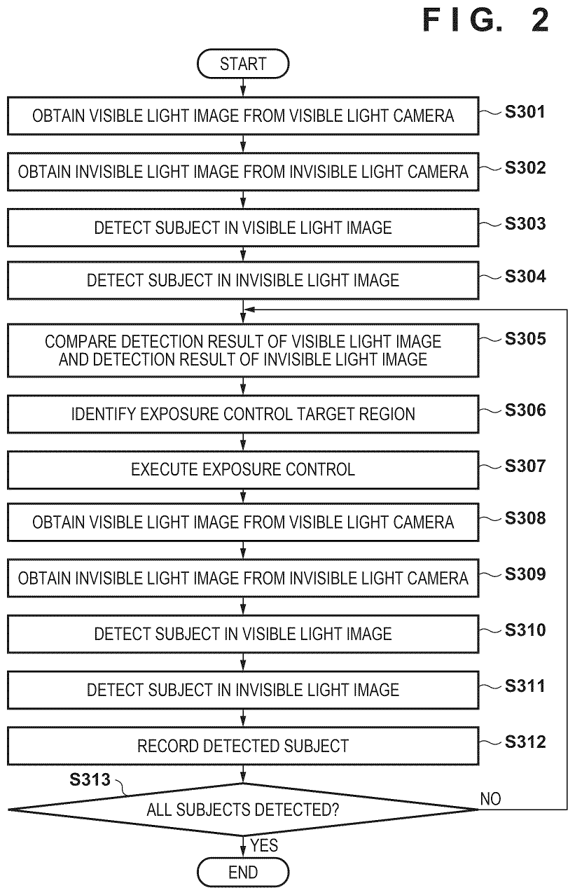

Next, exposure control for the visible light camera 101 by the image processing apparatus 103 will be described according to the flowchart of FIG. 2. The order of some processes may be changed as appropriate and some processes may be executed in parallel, not only in the flowchart of FIG. 2 but also in flowcharts to be used in the following description.

In step S301, the obtaining unit 201 obtains an image captured by the visible light camera 101 as a visible light image. In step S302, the obtaining unit 202 obtains an image captured by the invisible light camera 102 as an invisible light image.

In step S303, the detection unit 203 inputs the visible light image obtained in step S301 into the first model and performs operations of the first model and thereby detects one or more subjects in the visible light image.

In step S304, the detection unit 204 inputs the invisible light image obtained in step S302 into the second model and performs operations of the second model and thereby detects one or more subjects in the invisible light image.

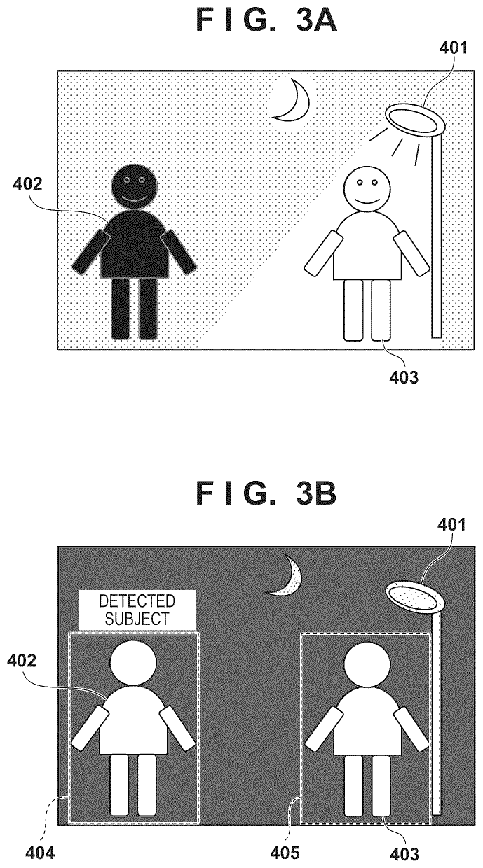

FIG. 3A illustrates an example of a visible light image in which a “scene where a light 401 is turned on in a localized manner in a dark environment at night and a person 402 is present in a dark portion and a person 403 is present in the light” is captured. FIG. 3B illustrates an example of an invisible light image obtained by capturing such a scene.

In the visible light image of FIG. 3A, the person 402 cannot be detected due to underexposure, and the person 403 cannot detected due to overexposure. Meanwhile, in the invisible light image of FIG. 3B, since far-infrared light is captured, the image is less affected by the light, and both the person 402 and the person 403 can be detected. In the example of FIG. 3B, a region within a frame 404 is detected as a region of the person 402, and a region within a frame 405 is detected as a region of the person 403.

In step S305, the comparison unit 205 identifies, as a non-corresponding region, a region among the regions of subjects detected in the invisible light image in step S304 that is not a detected subject region, which will be described later, and does not correspond to the regions of the subjects detected in a visible light image in step S303. Various methods can be applied to a method of identifying a non-corresponding region.

For example, the comparison unit 205 obtains Intersection over Unions (IoUs) of a region (first region) of a subject of interest detected in the invisible light image and regions (second regions) of all the subjects detected in the visible light image and, if all the obtained IoUs are less than a threshold, identifies the first region as a non-corresponding region. The comparison unit 205 performs such processing for all the regions of the subjects detected in the invisible light image. Something other than IoU may be used as a ratio of an overlap between the first region and the second region.

In the examples of FIGS. 3A and 3B, since a subject is not detected in the visible light image of FIG. 3A, there is no region for which an IoU with the region within the frame 404 or the region within the frame 405 in the invisible light image of FIG. 3B is obtained. Therefore, in this case, the region within the frame 404 or the region within the frame 405 is identified as a non-corresponding region.

Then, the comparison unit 205 generates, as region information, information defining the non-corresponding region in the invisible light image. The region information may be, for example, information indicating coordinate positions of the upper left corner and the lower right corner of the non-corresponding region or information indicating a coordinate position of the upper left corner of the non-corresponding region and vertical and horizontal sizes of the non-corresponding region.

In step S306, the exposure control unit 206 identifies, as an exposure control target region, a region defined by the region information in the visible light image, that is, a region corresponding to the non-corresponding region in the visible light image.

In step S307, the exposure control unit 206 calculates an average value (average luminance value) of luminance values of the exposure control target region. For example, the exposure control unit 206 calculates an average luminance value

Ī_{object}

of the exposure control target region according to following Equation (1).

$${\overline{I}}_{object} = \frac{1}{f} {\sum }_{s = 1}^{f} \{ \frac{1}{{k}_{s} \times {l}_{s}} {\sum }_{i = - {k}_{s} / 2}^{{k}_{s} / 2} {\sum }_{j = - {l}_{s} / 2}^{{l}_{s} / 2} l ( {v}_{s} + i , {h}_{s} + j ) \} \qquad ( 1 )$$

Here, I (x, y) represents a luminance value of a pixel of a coordinate position (x, y) (a horizontal direction is an x-axis direction and a vertical direction is a y-axis direction) in the visible light image. f represents the number of exposure control target regions, s represents the index of the exposure control target region, ks represents the horizontal size of the exposure control target region with index=s, and Is represents the vertical size of the exposure control target region with index=s. vs represents an x-coordinate position of a pixel at the center of the exposure control target region with index=s, and hs represents a y-coordinate position of the pixel at the center of the exposure control target region with index=s.

Next, the exposure control unit 206 determines an exposure correction amount EV correction based on the average luminance value. First, the exposure control unit 206 calculates a difference value ΔDiff between the average luminance value

Ī_{object}

and a target luminance value Iobject target according to following Equation (2).

$$Δ Diff = {I}_{object target} - {\overline{I}}_{object} \qquad ( 2 )$$

The target luminance value Iobject target, for example, may be arbitrarily set by the user or may be set to a value such that accuracy increases in consideration of subject detection and detection accuracy.

Next, the exposure control unit 206 determines the correction amount EV correction according to following Equation (3). EV current is an APEX conversion EV value based on the subject luminance value (BV value), which is stored in advance in the image processing apparatus 103, and is set based on a program diagram pertaining to exposure control.

$${EV}_{{correction}^{}} = \{ \begin{matrix}{EV}_{current} - β & if Δ Diff < - Th \\ {EV}_{current} & if - Th \leq Δ Diff \leq Th \\ {EV}_{current} + β & if Th < Δ Diff\end{matrix} \qquad ( 3 )$$

Here, β is a coefficient that affects the degree of correction (speed) for when correcting exposure to the underexposure side or the overexposure side, centered on the current exposure value EV current, and is a preset coefficient. Th is a preset threshold.

By setting the value of β to be large, the processing speed (or time) required for exposure to reach the target is fast, but the brightness of the entire screen drastically fluctuates when an erroneous determination occurs in the detection result or when subject detection is not stable. Meanwhile, when the value of β is set to be small, the processing speed (or time) required for exposure to reach the target is slow, but robustness to false detection and imaging conditions increases. When the difference value ΔDiff is the threshold Th or more, β is set as the exposure correction value for the present exposure value EV current.

Then, the exposure control unit 206 controls exposure of the visible light camera 101 by setting the visible light camera 101 to an exposure setting value that satisfies the correction amount EV correction. The processing of step S307 ends when EV correction=EV current in Equation (3).

The processing after step S308 is processing to be performed after exposure control for the visible light camera 101 in step S307. In step S308, the obtaining unit 201 obtains an image captured by the visible light camera 101 as a visible light image. In step S309, the obtaining unit 202 obtains an image captured by the invisible light camera 102 as an invisible light image.

In step S310, the detection unit 203 inputs the visible light image obtained in step S308 into the first model and performs operations of the first model and thereby detects one or more subjects in the visible light image.

In step S311, the detection unit 204 inputs the invisible light image obtained in step S309 into the second model and performs operations of the second model and thereby detects one or more subjects in the invisible light image.

In step S312, the comparison unit 205 identifies, as a corresponding region, a region among the regions of subjects detected in the invisible light image in step S311 that corresponds to a region of a subject detected in the visible light image in step S310. Various methods can be applied to a method of identifying a corresponding region.

For example, the comparison unit 205 obtains Intersection over Unions (IoUs) of a region (first region) of a subject of interest detected in the invisible light image and regions (second regions) of all the subjects detected in the visible light image and, if all the obtained IoUs are a threshold or more, identifies the first region as a corresponding region. The comparison unit 205 performs such processing for all the regions of the subjects detected in the invisible light image. Something other than IoU may be used as a ratio of an overlap between the first region and the second region.

Then, the comparison unit 205 sets the identified corresponding region as the region of the detected subject (detected subject region) and stores region information defining the detected subject region in a memory. The region information defining the detected subject region may be, for example, information indicating coordinate positions of the upper left corner and the lower right corner of the detected subject region or information indicating a coordinate position of the upper left corner of the detected subject region and vertical and horizontal sizes of the detected subject region. The memory for storing the region information defining the detected subject region may be a memory in the image processing apparatus 103 or may be a memory device connected to the image processing apparatus 103 or capable of communicating with the image processing apparatus 103.

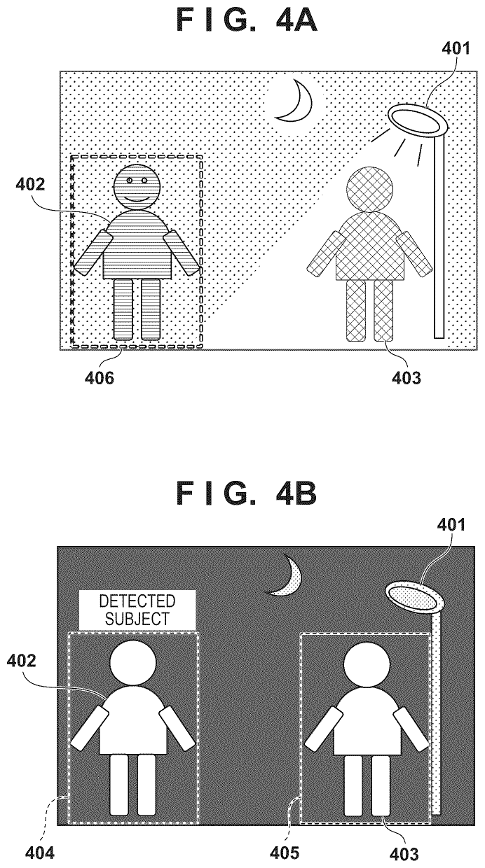

The processing of step S312 will be described with reference to concrete examples illustrated in FIGS. 4A and 4B. FIG. 4A illustrates an example of a visible light image obtained by capturing the same scene as the scene in FIGS. 3A and 3B with the visible light camera 101 after exposure control in step S307. FIG. 4B illustrates an example of an invisible light image obtained by capturing that scene with the invisible light camera 102.

As illustrated in FIG. 4A, in the visible light image captured after exposure control, the person 402 is detected, and a region within a frame 406 is detected as a region of the person 402. Here, if an IoU between the region within the frame 404 and the region within the frame 406 is a threshold or more, the region within the frame 404, that is, the region of the person 402 is set as the detected subject region, and region information of the detected subject region is stored in the memory.

In step S313, the comparison unit 205 determines whether region information has been stored in the memory for the regions of all the subjects in the invisible light image. As a result of this determination, if region information has been stored in the memory for the regions of all the subjects in the invisible light image, the processing according to the flowchart of FIG. 2 ends. Meanwhile, if there remains a region among regions of subjects in the invisible light image for which region information is yet to be stored in the memory, the processing proceeds to step S305.

In the examples of FIGS. 4A and 4B, since region information of the region within the frame 405 in the invisible light image is yet to be stored in the memory, the processing proceeds to step S305. In the case of FIGS. 4A and 4B, since the region within the frame 405 is a non-corresponding region, in step S305 the region within the frame 405 is identified as a non-corresponding region, and region information of that non-corresponding region is generated. In step S306, the exposure control unit 206 identifies, as an exposure control target region, a region corresponding to the “region within the frame 405” in the visible light image. Then, in step S307, the exposure control unit 206 controls exposure of the visible light camera 101 based on the exposure control target region. After this exposure control, the processing of steps S308 to S312 is performed.

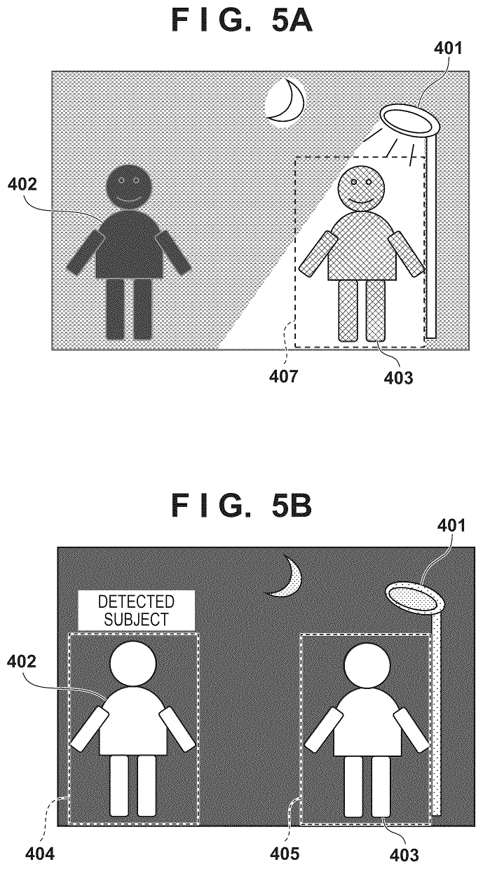

The processing in the second round of step S312 will be described with reference to concrete examples illustrated in FIGS. 5A and 5B. FIG. 5A illustrates an example of a visible light image obtained by capturing the same scene as the scene in FIGS. 3A and 3B with the visible light camera 101 after exposure control in the second round of step S307. FIG. 5B illustrates an example of an invisible light image obtained by capturing that scene with the invisible light camera 102.

As illustrated in FIG. 5A, in the visible light image captured after exposure control, the person 403 is detected, and a region within a frame 407 is detected as a region of the person 403. Here, if an IoU between the region within the frame 405 and the region within the frame 407 is a threshold or more, the region within the frame 405, that is, the region of the person 403 is set as the detected subject region, and information defining the detected subject region is stored in the memory.

In the example of FIGS. 5A and 5B, since region information of the regions of all the subjects in the invisible light image is stored in the memory, in step S313 the comparison unit 205 determines that region information is stored in the memory for all the regions of the subjects in the invisible light image. Therefore, in this case, the processing according to the flowchart of FIG. 2 ends.

Thus, in the present embodiment, exposure control is performed based on a region among regions of subjects detected in an invisible light image that is a region of a subject not detected in a visible light image. Further, by recording a once detected subject as a detected subject, it is possible to prevent exposure control from being performed repeatedly on the same subject. By doing so, it becomes possible to, for example, sequentially provide visible light images, for which exposure control that is desirable for a plurality of detected subjects has been performed, to a subsequent system (e.g., a system for authenticating a person by facial features, colors of clothing, etc.).

In the present embodiment, description has been given using, as an example, a case where two cameras, which are a visible light camera and an invisible light camera, are used. However, the present invention is not limited thereto, and for example, a single imaging apparatus including two sensors, which are a visible light sensor and an invisible light sensor, may be used, or an imaging apparatus including, in a single sensor, pixels for visible light and pixels for invisible light may be used. Thus, without limitation to the method of obtaining a visible light image and an invisible light image, the image processing apparatus 103 identifies a region among regions of subjects detected in a first image obtained by imaging in which invisible light is used that does not correspond to a region of a subject detected in a second image obtained by imaging in which visible light is used and, based on that identified region, controls exposure for imaging in which visible light is used.

Further, in the present embodiment, a case where each of the visible light camera 101, the invisible light camera 102, and the image processing apparatus 103 is a separate apparatus has been described. However, a single device in which the visible light camera 101, the invisible light camera 102, and the image processing apparatus 103 are integrated may be configured.

Further, in the present embodiment, description has been given using, as an example, a case where a subject is a person, but the subject is not limited to a specific subject, and various objects, such as animals, ships, and cars, for example, may be used as the subject.

The exposure control unit 206 may output a visible light image captured by the visible light camera 101 after exposure control. For example, the exposure control unit 206 may transmit a visible light image captured by the visible light camera 101 after exposure control to an external device via a network, such as a LAN or the Internet. An external device is, for example, a device/system that authenticates a person using facial features, colors of clothing, and the like of the person.

Further, the exposure control unit 206 may display a visible light image captured by the visible light camera 101 after exposure control on a display unit included in the image processing apparatus 103 or store the visible light image in a memory included in the image processing apparatus 103.

The exposure control unit 206 may output an invisible light image in addition to or in place of the visible light image. An output destination and an output form of the invisible light image are not limited to a specific output destination and a specific output form, similarly to the visible light image.

### Second Embodiment

Hereinafter, differences from the first embodiment will be described, and unless otherwise mentioned, it is assumed that the rest is the same as the first embodiment. A system according to the present embodiment is a system in which a detected subject is tracked using the technique according to the first embodiment, thereby preventing exposure control from being repeated on the same subject.

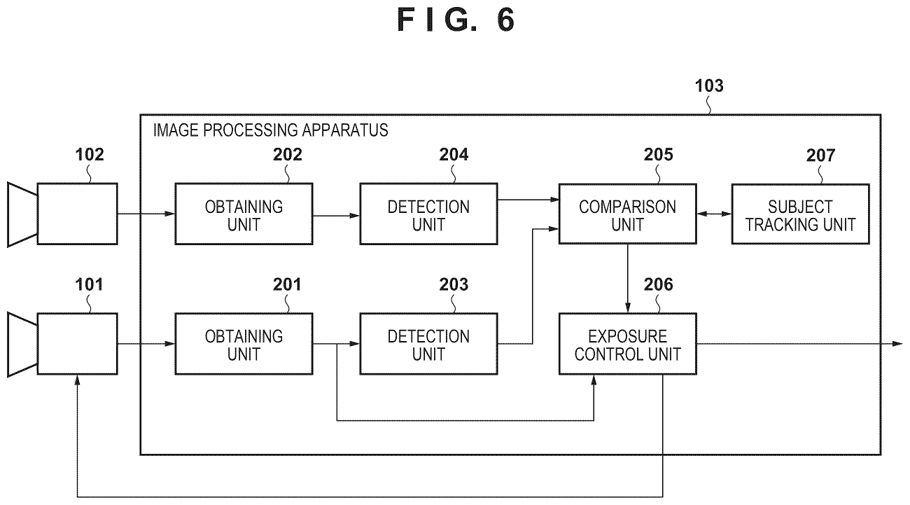

An example of a functional configuration of the system according to the present embodiment will be described with reference to a block diagram of FIG. 6. In FIG. 6, functional units similar to the functional units illustrated in FIG. 1 are denoted using the same reference numerals as those functional units, and the description pertaining to those functional units will be omitted.

A subject tracking unit 207 performs subject tracking processing, which processing for tracking, based on features, positional continuity, and the like of a subject, a region (detected subject region) indicated by “region information of the detected subject region” stored in the memory by the comparison unit 205.

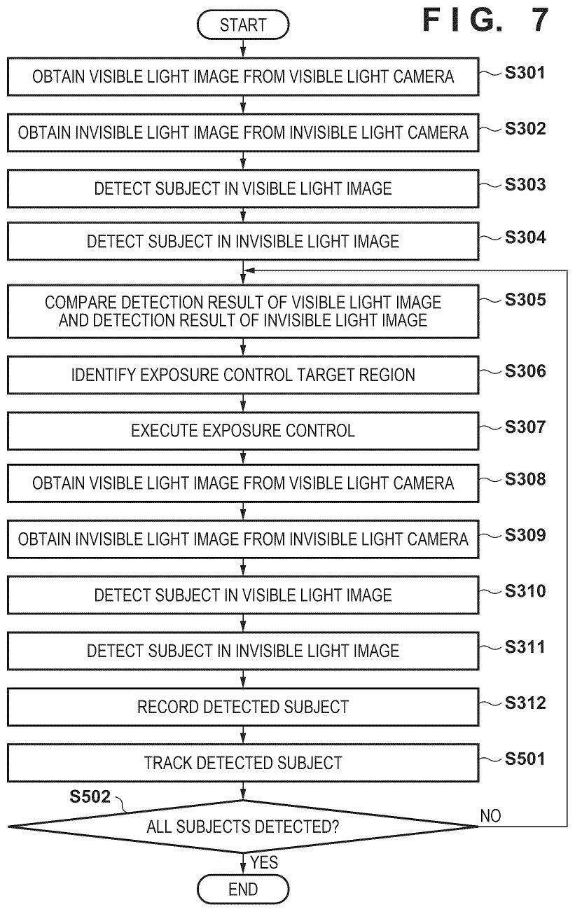

Next, the subject tracking processing by the image processing apparatus 103 will be described according to the flowchart of FIG. 7. In FIG. 7, processing steps similar to the processing steps of FIG. 2 are denoted using the same step numerals as those processing steps, and the description pertaining to those processing steps will be omitted.

In step S501, the subject tracking unit 207 performs subject tracking processing, which is processing for tracking, based on features, positional continuity, and the like of a subject, a region (detected subject region) indicated by “region information of the detected subject region” stored in the memory in step S312. In the examples of FIGS. 4A and 4B, the subject tracking unit 207 performs subject tracking processing in which the region within the frame 404 is tracked.

In step S502, the comparison unit 205 determines, for regions of all the subjects in the invisible light image, whether region information defining that region has been stored in the memory. As a result of this determination, if it is determined for the regions of all the subjects in the invisible light image that region information defining that region has been stored in the memory, the processing according to the flowchart of FIG. 7 ends. Meanwhile, if it is determined that there remains a region among regions of subjects in the invisible light image for which region information is yet to be stored in the memory, the processing proceeds to step S305.

In the examples of FIGS. 4A and 4B, since region information of the region within the frame 405 in the invisible light image is yet to be stored in the memory, the processing proceeds to step S305. In the case of FIGS. 4A and 4B, since the region within the frame 405 is a non-corresponding region, in step S305 the region within the frame 405 is identified as a non-corresponding region, and region information of that non-corresponding region is generated. In step S306, the exposure control unit 206 identifies, as an exposure control target region, a region corresponding to the “region within the frame 405” in the visible light image. Then, in step S307, the exposure control unit 206 controls exposure of the visible light camera 101 based on the exposure control target region. After this exposure control, the processing from step S308 onward is performed.

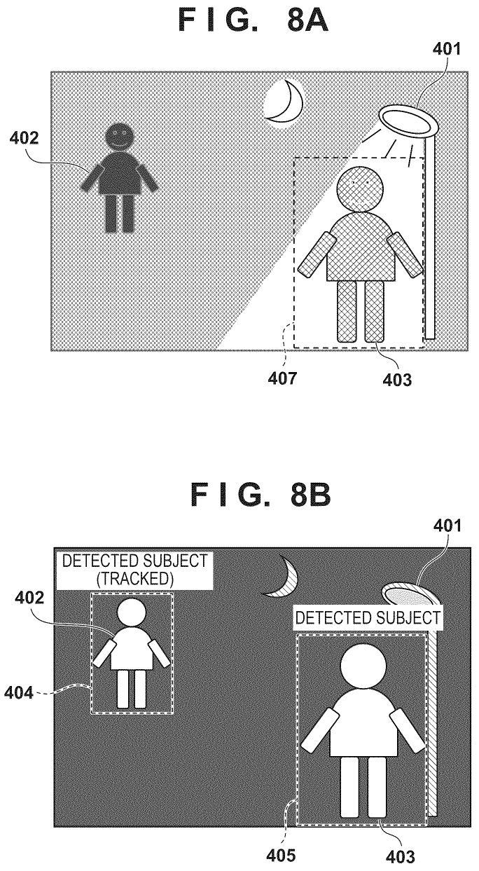

The processing in the second round of step S308 onward will be described with concrete examples illustrated in FIGS. 8A and 8B. FIG. 8A illustrates an example of a visible light image obtained by capturing the same scene (however, the person 402 has moved) as the scene in FIGS. 3A and 3B with the visible light camera 101 after exposure control in the second round of step S307. FIG. 8B illustrates an example of an invisible light image obtained by capturing that scene with the invisible light camera 102.

As illustrated in FIG. 8A, in the visible light image captured after exposure control, the person 403 is detected, and a region within a frame 407 is detected as a region of the person 403. Here, if an IoU between the region within the frame 405 and the region within the frame 407 is a threshold or more, the region within the frame 405, that is, the region of the person 403 is set as the detected subject region, and information defining the detected subject region is stored in the memory.

Then, as illustrated in FIG. 8B, since the person 402 has moved, region information of the region of the person 402 after movement (region within the frame 404) is not stored in the memory, but since the region within the frame 404 is a tracking target, in this case it is determined that “region information of the region within the frame 404 is stored in the memory”. Therefore, since region information of each of the region within the frame 404 and the region within the frame 405 is stored in the memory at this time, the processing according to the flowchart of FIG. 7 ends.

In step S501, the subject tracking unit 207 may track, based on features, positional continuity, and the like of a subject, a region of an invisible light image that corresponds to a region in which exposure control by the exposure control unit 206 has been completed. By doing so, even in cases such as those where there is false detection in the invisible light image (a subject cannot be detected in the visible light image even upon exposure control), for example, it is possible to prevent exposure adjustment from being repeated on the same region.

### Third Embodiment

Hereinafter, differences from the first embodiment and the second embodiment will be described, and unless otherwise mentioned, it is assumed that the rest is the same as the first embodiment and the second embodiment. A system according to the present embodiment is a system in which, when a plurality of regions are identified as subject regions, region information of a non-corresponding region satisfying a condition is generated as a region in which, in the comparison unit 205, processing is to be preferentially performed in the processing of step S306 onward. Since the processing from steps S301 to S304 in FIG. 2 is the same as that of the first embodiment, description will be omitted.

In step S305, the comparison unit 205 identifies, as a non-corresponding region, a region among the regions of subjects detected in the invisible light image in step S304 that is not a detected subject region, which will be described later, and does not correspond to the regions of the subjects detected in the visible light image in step S303. Similarly to the first embodiment, various methods can be applied to the method of identifying a non-corresponding region.

Here, when a plurality of regions are identified as non-corresponding regions, the comparison unit 205 may generate region information of a non-corresponding region satisfying the condition as a region on which the processing from step S306 onward is prioritized or to which the processing from step S306 onward is limited.

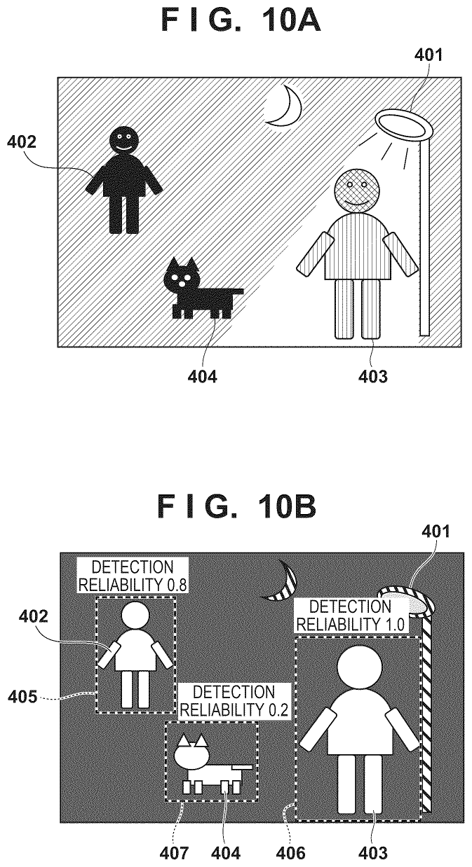

For example, the comparison unit 205 may perform generation such that a non-corresponding region with a high detection reliability is prioritized based on a detection reliability obtained from the detection unit 204. By performing generation in this way, it is possible to reduce effects of false detection in an invisible light image that are thought to occur to some extent in step S304. In the examples of FIGS. 10A and 10B, since a subject is not detected in the visible light image of FIG. 10A, there is no region for which an IoU with the region within the frame 405, the region within a frame 406, or the region within a frame 407 in the invisible light image of FIG. 10B is obtained. Therefore, in this case, the region within the frame 405, 406, are 407 identified as non-corresponding regions. Here, as illustrated in FIG. 10B, a detection reliability for when a subject detection target in each region is a person is 1.0 for the person 403, 0.8 for the person 402, and 0.2 for an animal 404. By limiting regions to those with a detection reliability exceeding a fixed threshold 0.5 and generating non-corresponding regions, subsequent processing will not be performed on the animal 404, which is not a person, and prevention of false detection is achieved. Further, as a configuration in which a threshold is not set and processing in which those with a high detection reliability is prioritized is performed, a configuration may be taken so as to postpone processing for those with a low detection reliability.

Further, for example, when brightnesses among non-corresponding regions greatly differ, there may be a case where exposure cannot be controlled to be desirable for a plurality of non-corresponding regions at the same time. In such a case, the comparison unit 205 may prioritize a non-corresponding region determined to be close in brightness according to a defined index and generate region information. By performing generation in this way, it is possible to reduce the amount of change in exposure in subsequent steps from step S306 onward, and it is possible to quickly execute exposure control.

Further, for example, the comparison unit 205 may prioritize a subject region with a high movement speed between frames and generate region information or may prioritize a subject close to an edge portion of the field of view and generate region information. This is based on a concept of generating region information for a subject that is likely to fall outside of the field of view when the subject moves. For example, when a high-speed subject moves across within the frame, it is possible to prioritize that subject and perform recognition.

In addition, for example, the comparison unit 205 may assign priorities to a plurality of subject regions based on the learning model used in the detection unit 204 and generate region information. In the present embodiment, as described above, detection is performed using the first trained model in which face or color information is used and the second trained model in which a silhouette of a human body is used. Here, it is considered that, compared to the detection result of the second trained model, the first trained model is capable of detecting details of a subject, and a likelihood of being that subject is higher. Therefore, for example, the comparison unit 205 may prioritize a region detected using the first trained model than that detected using the second trained model and generate region information. Since the processing from step S306 onward is similar to that of the first embodiment, description will be omitted.

As described above, in the present embodiment, when a plurality of regions are identified as non-corresponding regions, region information satisfying a condition is generated as a region on which subsequent processing is prioritized or to which the subsequent processing is limited. By performing such processing, even when there are a plurality of recognition targets on a screen, it is possible to limit subjects to be recognized or execute subsequent recognition processing in order from a subject considered a high priority.

### Fourth Embodiment

Each functional unit of the image processing apparatus 103 illustrated in FIGS. 1 and 6 may be implemented in software (computer program) or in hardware. In the former case, each functional unit may be implemented in hardware, such as an A SIC or a programmable logic array (PLA). A SIC is an abbreviation of application specific integrated circuit. Some functional units among the respective functional units may be implemented in hardware.

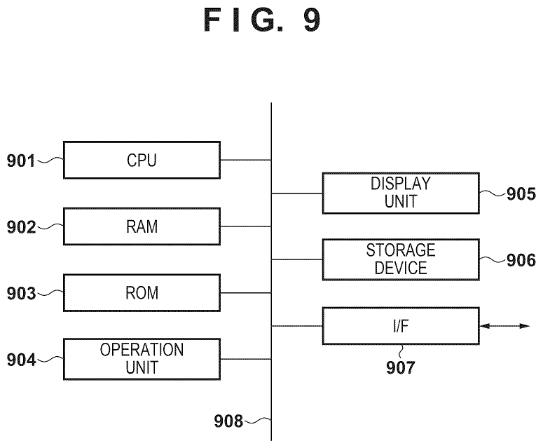

Further, in the latter case, a computer apparatus capable of executing such a computer program can be applied to the image processing apparatus 103. An example of a hardware configuration of a computer apparatus applicable to the image processing apparatus 103 will be described with reference to a block diagram of FIG. 9. A computer apparatus, such as a PC, a tablet terminal device, or a smartphone, is applicable to such a computer apparatus.

A CPU 901 executes various processes using computer programs and data stored in a RAM 902 or a ROM 903. The CPU 901 thus performs control of operation of the entire computer apparatus and executes or controls various processes described as processes to be performed by the image processing apparatus 103. A programmable processor, such as an MPU, may be used in place of the CPU 901. CPU is an abbreviation of central processing unit. MPU is an abbreviation of micro-processing unit.

The RAM 902 includes an area for storing computer programs and data loaded from the ROM 903 and a storage device 906 and an area for storing computer programs and data received externally via an I/F 907. Further, the RAM 902 includes a work area that the CPU 901 uses when performing various processes. The RAM 902 can thus provide various areas as appropriate.

The ROM 903 stores setting data of the computer apparatus, computer programs and data related to startup of the computer apparatus, computer programs and data related to a basic operation of the computer apparatus, and the like.

An operation unit 904 is a user interface such as a keyboard, a mouse, and a touch panel screen, and can input various kinds of instructions and information to the computer apparatus by being operated by the user.

A display unit 905 includes a liquid crystal screen or a touch panel screen, and can display a result of processing by the CPU 901 by using images, characters, and the like. The display unit 905 may be a projection device such as a projector for projecting images and characters.

The storage device 906 is a mass information storage device such as a hard disk drive device. The storage device 906 stores an operating system (OS), computer programs and data for causing the CPU 901 to execute or control various processes described as processes to be performed by the image processing apparatus 103, and the like. The computer programs stored in the storage device 906 may include a computer program for causing the CPU 901 to execute or control the functions of each functional unit of the image processing apparatus 103 illustrated in FIGS. 1 and 6. The data stored in the storage device 906 may include known parameters, such as the above thresholds. Further, a configuration may be taken such that images captured by the visible light camera 101 and the invisible light camera 102 are stored in the storage device 906 and the CPU 901 reads these image as necessary and executes the processing. For example, the RAM 902 or the storage device 906 can be applied to the above memory mentioned in the description of the first embodiment and the second embodiment.

The I/F 907 is a communication interface for performing data communication with an external apparatus via a network, such as a LAN or the Internet. For example, the computer apparatus can obtain images captured by the visible light camera 101 and the invisible light camera 102 via the I/F 907. Further, the computer apparatus can output various kinds of information described as information to be outputted by the exposure control unit 206 to an external device via the I/F 907.

The CPU 901, the RAM 902, the ROM 903, the operation unit 904, the display unit 905, the storage device 906, and the I/F 907 are all connected to a system bus 908. A hardware configuration of a computer apparatus applicable to the image processing apparatus 103 is not limited to a configuration illustrated in FIG. 9 and can be appropriately modified/changed.

The configuration of the system described in each of the above embodiments may be appropriately modified or changed depending on, for example, specification and various conditions (use conditions, use environment, etc.) of an apparatus to be applied to the system, and the configuration indicated in each of the above embodiments is only an example.

The numerical values, processing timing, processing order, processing entity, data (information) configuration/obtainment method/transmission destination/transmission source/storage location, and the like used in each of the above embodiments have been given as examples for the sake of providing a concrete explanation, and the present invention is not intended to be limited to such examples.

Further, some or all of the respective embodiments described above may be appropriately combined and used. Further, some or all of the respective embodiments described above may be selectively used. Further, not all of the configurations of the respective embodiments described above are necessarily required.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (A SIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-079715, filed May 15, 2024, and Japanese Patent Application No. 2024-210772, filed Dec. 3, 2024 which are hereby incorporated by reference herein in their entirety.

What is claimed is:

1. An image processing apparatus comprising:
an identification unit configured to identify a region, among regions of subjects detected in a first image obtained by imaging in which invisible light is used, that does not correspond to a region of a subject detected in a second image obtained by imaging in which visible light is used; and
a control unit configured to control, based on the region identified by the identification unit, exposure for imaging in which visible light is used.

2. The image processing apparatus according to claim 1, wherein,
the identification unit identifies a region, among regions of subjects detected in the first image, whose ratio of overlap with a region of a subject detected in the second image is less than a threshold.

3. The image processing apparatus according to claim 1, wherein
the control unit controls, based on regions, among regions identified by the identification unit, that are determined to be close in brightness according to a defined index, exposure for imaging in which visible light is used.

4. The image processing apparatus according to claim 1, wherein
the control unit controls, based on a region, among regions identified by the identification unit, that is a region of a subject whose movement speed between frames is a threshold or more, exposure for imaging in which visible light is used.

5. The image processing apparatus according to claim 1, wherein
the control unit controls, based on a region, among regions identified by the identification unit, that is a region of a subject within a defined distance from an edge portion of a field of view, exposure for imaging in which visible light is used.

6. The image processing apparatus according to claim 1, wherein
the control unit obtains an average luminance value of the region identified by the identification unit and controls, based on a difference between that average luminance value and a target luminance value, exposure for imaging in which visible light is used.

7. The image processing apparatus according to claim 1, further comprising:
a tracking unit configured to track the region identified by the identification unit.

8. The image processing apparatus according to claim 7, wherein
the tracking unit tracks a region on which exposure control has been performed by the control unit.

9. The image processing apparatus according to claim 1, wherein
the first image and the second image are captured by a single imaging apparatus including a visible light sensor and an invisible light sensor.

10. The image processing apparatus according to claim 1, wherein
the first image and the second image are captured by an imaging apparatus including pixels for visible light and pixels for invisible light on one sensor.

11. An image processing method to be performed by an image processing apparatus, the method comprising:
identifying a region, among regions of subjects detected in a first image obtained by imaging in which invisible light is used, that does not correspond to a region of a subject detected in a second image obtained by imaging in which visible light is used; and
controlling, based on the identified region, exposure for imaging in which visible light is used.

12. A non-transitory computer-readable storage medium storing a computer program for causing a computer to function as:
an identification unit configured to identify a region, among regions of subjects detected in a first image obtained by imaging in which invisible light is used, that does not correspond to a region of a subject detected in a second image obtained by imaging in which visible light is used; and
a control unit configured to control, based on the region identified by the identification unit, exposure for imaging in which visible light is used.
